(19) United States
(12) Patent Application Publication
(10) Pub. No.: US 2011/0237373 A1
(43) Pub. Date: Sep. 29, 2011

(54) AUTOMATIC BELT TENSIONING SYSTEM

(76) Inventors: GUILLERMO MORALES BARRIOS, NUEVO LEON (MX); HECTOR VALDEZ JARAMILLO, NUEVO LEON (MX); GERARDO ANGEL GONZALEZ CHAPA, NEUVO LEON (MX)

(21) Appl. No.: 12/730,075

(22) Filed: Mar. 23, 2010

(51) Int. Cl. F16H 7/14

(52) U.S. Cl. 474/113

(57) ABSTRACT

A device and method of use of that device to automatically adjust the tension of a belt(s) used in a driven system is disclosed. The system includes at least one driving device or power source and at least one driven device. The system further includes a tensioning member that serves to continuously compensate for slack which naturally develops in the belt or belts during normal operation of the system, as well as preloading the device with the appropriate amount of tension. The device provides a manually operated adjustment which allows for user control of the tensioning member, as well as an indicator which displays the amount of elongation of a belt and/or the desired preloaded tension of the system, thus simplifying removal, application, and replacement of belts, etc.

### FIELD OF THE INVENTION

The field of the present disclosure is directed to a belt tensioning system comprising an engine or energy source, one or more driven devices and an adjustment mechanism. More particularly, the present disclosure is directed to a method and system for the automatic adjustment of drive belt tension which includes an adjustment mechanism which facilitates efficient application and release of drive belt tension and promotes safe, quick, and easy replacement of worn or damaged belts.

### BACKGROUND OF THE INVENTION

It is often desirable to employ a mechanism or system that applies appropriate tension to a drive belt in a driven system. In these systems, it is desirable to maintain a relatively constant amount of tension on the drive belt so as to avoid the reduced overall performance of the system, as well as reduce the risk of belt slippage and damage to bearings on an energy source or driven member used in the system. Furthermore, as belt driven systems periodically require the replacement of belts after belt failure or wear, it is also desirable to provide a method and system for quickly, safely, and easily reducing or eliminating belt tension in the system in order to remove and replace belts with minimal effort and system down time.

Belt tensioning systems are generally known in the art. For example, U.S. patent application Ser. No. 11/896,518 to Lindemann discloses a belt tensioner system with an adjustable slider plate and is hereby incorporated by reference in its entirety. Lindemann utilizes a spring loaded tensioner system with a knob to manually adjust the tension applied to the drive belt. However, Lindemann does not teach an integrated system wherein the driven device or devices are translated to provide constant tension on a drive belt. Lindemann also does not teach a method or system where feedback is provided to an operator to assist that operator in determining both the appropriate amount of preliminary tension to be applied to a drive belt, as well as, the amount of elongation or strain experienced by the drive belt at any given point in time.

Similarly, U.S. Pat. No. 6,575,858 to Green et al., which is incorporated herein by reference in its entirety, discloses a drive belt tensioning system and method using a spring-loaded tensioner arm mounted on a base plate. Green et al., however, fails to disclose a system where the belt driven device or devices are displaced relative to the driving device, nor is feedback on the displacement of the spring and driven device provided to a user.

U.S. Pat. Nos. 5,975,480 to Schaefer et al. and 3,652,044 to Manross, which are incorporated by reference in their entireties, disclose motor mounts with the ability to adjustably locate the motor. Shaefer et al. and Manross fail to teach, however, novel aspects of the present invention, including but not limited to the automatic tension adjustment to a drive belt that occurs during prolonged motor or engine operation.

Thus, there has been a long felt need to provide a system to automatically adjust the tension of a driven belt that occurs automatically during use of that belt and in a variety of environments. There has also been a long felt need to provide feedback to an operator on the need to replace a worn belt utilized in an automatic drive belt tensioning system. Finally, there has been a long felt need to provide information to an operator concerning the appropriate amount of preliminary tension to be applied to a drive belt, as well as the amount of elongation or strain experienced by the drive belt at a given point in time. The following disclosure describes an improved automatic belt tensioning system that employs a novel combination of features that address all of these long felt needs.

### SUMMARY OF THE INVENTION

According to varying embodiments of the present disclosure, a self-adjusting tension method and system for use in belt driven devices is disclosed. The system comprises at least one driving device and at least one driven device. For the purposes of disclosing aspects of the present invention, self-adjusting refers to the ability of a system to account for loss of tension in belts due to wear, elongation and strain while the system is running or in operation for various lengths of time.

The system may also comprise a base plate upon which the previously described aspects reside, as well as at least one slider plate or mount upon which the driven device(s) may reside. Additionally, a reference point is included in association with the slider plate to indicate the distance the driven device has moved from an original location due to gradual elongation of a belt. The reference point may preferably take the form of a slider slot formed in the aforementioned slider plate or mount, which reveals a protruding object, also sometimes referred to as a visual indicator which may be fixed in relation to the driven device. Alternatively, the reference point may take the form of a scale or marking on a base plate, slider plate, or both.

In one embodiment, the system further comprises a method for replacing worn or damaged belts wherein a handle or manually operated device is used to either partially or fully adjust the tension of a spring which may be used in the system. By adjusting the spring's tension, a user is allowed to reposition driven devices so that they are in relative proximity to the driving device. By doing so, worn belts are safely and easily removed from the system, while new belts are safely and easily re-applied to the system.

The system and process described herein thus provides a device and method for operating a belt driven system with at least one driven device. The system and process further facilitate both the removal and application of belts, resulting in a decrease in the required down time for belt repair and replacement and greater utility of the system to the user. Thus, according to one embodiment of the present disclosure, an integrated belt driven system with automatic tension adjustment is disclosed, comprising:

at least one driving device;

at least one driven device, connected to the engine by one or more belts;

at least one tensioning device for each of the at least one driven devices capable of applying tension while the driven devices are driven;

a manually operated adjustment device that allows for the at least one tensioning device to be adjusted;

at least one indicator to display to a user at least one of: the displacement of the driven device, the displacement of the at least one tensioning device, the most desired location of the driven device, and the least desired location of the driven device.

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described in detail below. Further, the summary of the invention is neither intended nor should it be construed as being representative of the full extent and scope of the present invention. The present invention is set forth in various levels of detail in the summary of the invention, as well as, in the attached drawings and the detailed description of the invention and no limitation as to the scope of the present invention is intended to either the inclusion or non-inclusion of elements, components, etc. in this summary of the invention. Additional aspects of the present invention will become more readily apparent from the detailed description, particularly when taken together with the drawings.

### BRIEF DESCRIPTION OF THE DRAWINGS

The accompanying drawings, which are incorporated in and constitute part of the specification, illustrate embodiments of the invention and together with the general description of the invention given above and the detailed description of the drawings given below, serve to explain the principle of these inventions.

FIG. 1 is a perspective view of the belt tensioning system including a single driving device and a single driven device.

FIG. 2 is a detailed perspective view of the embodiment of FIG. 1.

FIG. 3 is a second detailed perspective view of the embodiment of FIG. 1.

FIG. 4 is an exploded perspective view of a portion of one embodiment of the disclosed belt tensioning system.

FIG. 5 is an elevation view of the belt tensioning system depicting possible operation of the manually operable adjustment.

FIG. 6 is a top view of the belt tensioning system.

FIG. 7 is a flowchart depicting a method for the removal and replacement of belts according to the disclosed belt tensioning system.

FIG. 8 is an exploded perspective view of another disclosed belt tensioning system.

FIG. 9 is a perspective view of another disclosed belt tensioning system.

To assist in the understanding of one embodiment of the present invention, the following list of components and associated numbering found in the drawings is provided:

| # | Component |
|---|---|
| 10 | Manually Operable System |
| 14 | Platform |
| 18 | Energy Source |
| 22 | Driven Device |
| 26 | Driven Device Base |
| 30 | Handle |
| 32 | Bracket |
| 33 | Rod |
| 34 | Indicator |
| 36 | Aperture |
| 38 | Belt |
| 42 | Driven Pulley |
| 44 | Driving Pulley |
| 48 | Slot |
| 50 | Optimum Tension Mark |
| 52 | Bolt |
| 54 | Nut |
| 56 | Shoulder Bushing |
| 60 | Spring |
| 64 | Nut |
| 68 | Additional Driven Device |
| 72 | Wheels |
| 76 | Rotation of Handle |
| 80 | Resistance Force |
| 84 | Translation of Nut |
| 88 | Direction of Belt Tension |
| 92 | Direction of Translation |
| 100 | Process Step |
| 104 | Process Step |
| 108 | Process Step |
| 112 | Process Step |
| 116 | Process Step |
| 120 | Process Step |
| 124 | Process Step |
| 128 | Process Step |
| 132 | Process Step |
| 136 | Process Step |
| 140 | Process Step |

It should be understood that the drawings are not necessarily to scale. In certain instances, details that are not necessary for an understanding of the invention or that render other details difficult to perceive may have been omitted from these drawings. It should be understood, of course, that the invention is not limited to the particular embodiments illustrated in the drawings.

### DETAILED DESCRIPTION

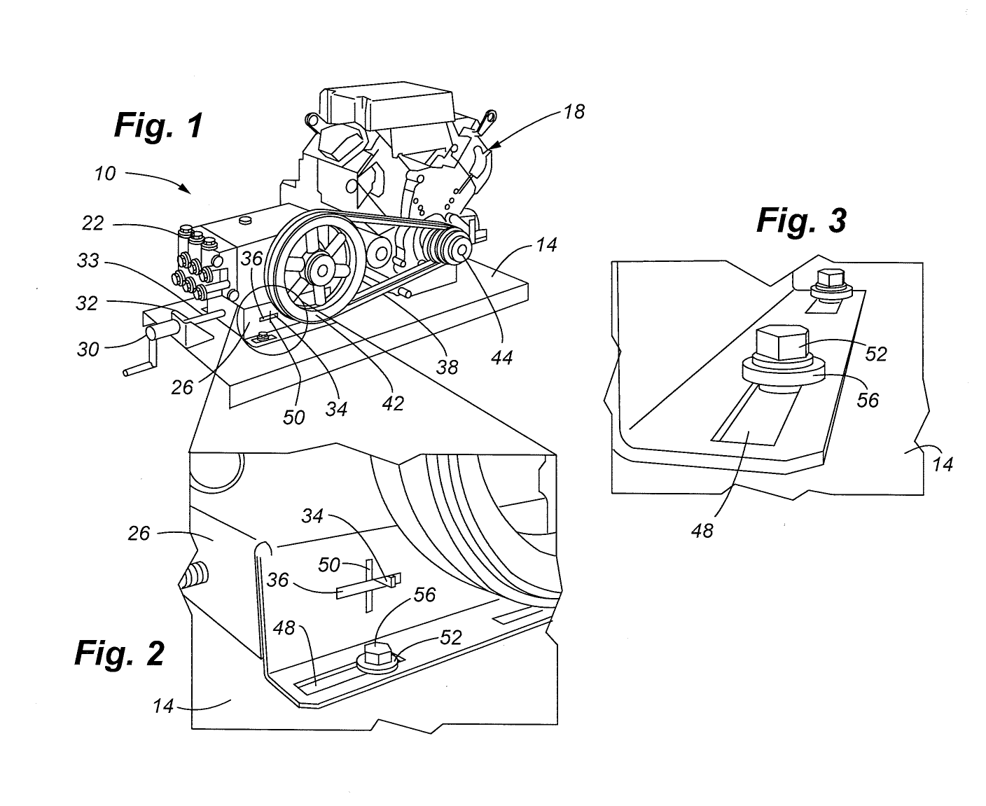

Varying embodiments of the present disclosure are described herein with reference to the drawings. It is expressly understood that although FIGS. 1-9 depict a self-contained and automatically adjusting belt tensioning system, the present invention is not limited to these specific disclosed embodiments.

FIG. 1 is a perspective view of one embodiment of a self-contained and automatic tension adjusting belt driven system 10 employing a single driving engine 18 and a single driven device 22. As will be appreciated, the driving device 18 need not be of any particular form. In a preferred embodiment, the driving device 18 is an internal combustion engine that drives a rotational shaft connected to a pulley 44. However, various devices known to one of ordinary of skill in the art, such as electric motors, turbines, or any device capable of converting force to motion would serve the purpose of the present invention. Driven devices contemplated by the present invention include but are not limited to pumps, vacuum pumps, compressors, pressure washers, generators, or any number of rotary devices such as lathes or other rotary tools. Indeed, the driven device 22 may be comprised of a variety of devices, as will be appreciated by skilled artisans, depending upon the desired application.

In one embodiment, the driving device 18 is connected to a driven device 22 by pulleys 44 and 42 which are connected by a drive belt 38. Belt 38 transmits force from the driving device 18 to a driven device 22. It will be recognized that drive belt 38 may be substituted with a variety of other force transmitting devices without violating the spirit of the present invention. For example, belt 38 may be substituted with a drive chain, cable, rope, etc.

It will be recognized that as the present invention 10 operates, the stress applied through tension to the belt 38 will gradually elongate the belt or other device. The elongation, if left unremedied, will result in undesired slack in the drive belt 38 or other device. For example, the presence of slack in a drive belt is known to cause sag and slippage of the belt, which reduces the efficiency of the overall system. Accordingly, an aspect of the present invention is the ability of the driven device 22 to translate or move relative to the driving device 18 so that a substantially constant and proper tension is present in the belt 38 during extended periods of operation, despite gradual elongation of the belt 38.

In a preferred embodiment, the translation of the driven device 22 is partially accomplished through the incorporation of slots or recesses 48 in a base portion 26 of the belt driven system 10. The driven device 22 and its base portion 26 are mounted on a platform or skid 14 by fastening assembly 52, 56 oriented through the slots 48 (described in more detail below). In a preferred embodiment, the fastening assembly is applied in a manner that prohibits the movement of the driven device in a direction normal to the platform 14, while allowing for the driven device 22 to move in a direction substantially parallel to the platform. The limited freedom of movement (i.e. in only one axis or direction), allows for the necessary stability and rigidity of the driven device 22, while also allowing for the driven device 22 to move relative to the driving device 18, thus allowing for automatic removal of belt slack created when the belt 38 stretches.

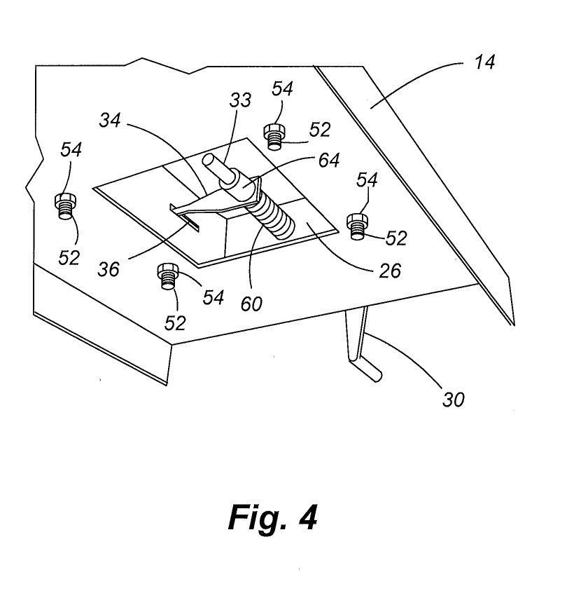

In order to accomplish the movement of the driven device 22 relative to the driving device 18, the present invention contemplates the use of at least one belt tensioning device. As will be described, the tensioning device preferably takes the form of a spring which continuously imparts longitudinal force upon the driven device 22 in a direction opposite the force of tension present in the belt 38. Through use of the spring 60 shown in FIG. 4, or a similar tension imparting member, and the previously described slots 48 and fastening assembly 52, 56, the driven device 22 is gradually allowed to translate away from the driving device 18 as the belt 38 elongates or strains. In this manner, substantially constant tension is applied to the drive belt 38, resulting in longer periods of proper operation for the overall system without the need for constant manual adjustment of the belt tension, providing greater overall utility of the system to the user. Although a spring and/or a biasing member are referenced in the description of various embodiments herein, it will be recognized that this element 60 need not be of any particular form. More specifically, the present disclosure contemplates the use of various members, including those that apply a constant force and those that apply non-constant force, to comprise element 60. The present invention is not limited to a spring that exerts a force as a function of displacement or a device that operates to apply a constant force.

The present invention 10 also preferably includes a manually operable device 30, 33. The device can include a threaded rod 33 which is secured in a direction normal to the platform 14 by non-threaded through holes in a support bracket 32 and the driven device 22 base 26. The rod 33 is preferably operated by a handle 30, located at one end of the rod 33. It will be recognized that the purpose of this handle 30 is to impart rotational torque about the rod 33 and induce rotational movement. Accordingly, it will be recognized that the handle 30 may be substituted with any number of known devices capable of accomplishing the stated objective. For example, a servo-motor operated by a manual switch may be substituted for the handle 30, etc.

As will be described further below, a nut or jackscrew is located within the base 26 of the driven device 22 and mounted on the rod 33. In a preferred embodiment, this nut (not shown in FIGS. 1-3, but shown as 64 in FIG. 4) preferably includes an extension 34 which extends through a slot or aperture 36 in the base 26 of the driven device 22. The extension 34 serves the dual purpose of providing information to the user of the device as to the relative position of the driven device 22 with respect to an original position, and/or with respect to the nut 64, as well as providing a moment arm that opposes the torque created when rod 33 is rotated.

One of ordinary skill in the art will recognize that where the threaded rod 33 is rotated and, if the nut 64 located on the rod is not allowed to simultaneously rotate, the force applied by the handle 30 and the opposing force applied by the nut extension, i.e. indicator 34, being in contact with a peripheral wall of the slot 36, will force the nut to move or creep along the rod 33. The movement of the nut as described herein provides the ability to appropriately compress or expand a spring (within operational limits) that is situated between an inner wall of the base 26 of the driven device 22 and the nut 64. Furthermore, the nut 64 provides sufficient resistance to the spring force via the friction along its threads, allowing the spring 60 to apply force to the base 26 of the driven device 22. It will be understood that these components, working together, accomplish a feature of the present invention whereby the driven device 22 is gradually translated away from the driving device 18 on the base 26, thus keeping constant tension on a belt of the device. It will be appreciated by those skilled in the art that the same longitudinal movement of the driven device 22 could be accomplished in any number of ways without use of a base 26.

With reference to the foregoing discussion, the base 26 of a driven device 22 can be translated to its furthest possible location with respect to the driving device 18. In a preferred embodiment, the driven device may be positioned prior to operation so that the bolt 52 and corresponding shoulder bushings 56 are located either in a central location with respect to the slot 48 or at a location furthest from the driving device 18. FIG. 2 depicts a driven device 22 that has been translated to the maximum allowable extent away from a driving device 18 and thus requiring a change of the belt 38. This is indicated by both the location of the bolt assembly 52, 56 within the slot 48 and the location of the extension 34. Once the driven device 22 has arrived at this location, it will be necessary to change the worn belt 38. The present invention facilitates this process by operating the previously described handle 30, rod 33, and nut indicator 34, as will now be further described below.

Once the device is powered down, a user may activate the handle 30 so as to induce the nut 64 and indicator 34 to move along the rod 33 in a manner that extends the spring 60 into a non-tensioned condition. Once the spring is positioned so that it is in a state of no or limited tension, the driven device 22 may then be translated back toward the driving device 18. As will be understood by skilled artisans, the driven device 22 may be either repositioned at, near, or beyond its original starting position. By positioning the driving and driven devices proximal to each other in this manner, the belt 38 is placed in a slack state where it may easily be removed for repair or replacement with a new belt.

In a preferred embodiment, an optimum starting tension mark 50 is included on the base of the driven device for a preferred new drive belt 38. The starting optimum tension mark allows a user to determine the appropriate amount of tension and corresponding position of both the nut 64 and the driven device 22 prior to operation when a new and proper belt is used in the system. Obviously, the optimum starting tension mark 50 could be placed anywhere along slot 36 depending upon the position of the indicator 34 when a new belt is utilized with the overall system and appropriately tensioned.

FIG. 4 is a bottom perspective view depicting operation of the rod 33, indicator 34, nut 64, and spring 60 according to one embodiment of the disclosure. As previously described, the rod 33 passes through a non-threaded through hole in the base 26 of a driven device 22. A nut 64 is located on the rod 33 and within the base 26. The nut 64 further includes an indicator 34 to provide feedback to a user and opposes rotational movement of the nut 64 when the rod 33 is turned. A spring 60 is disposed between the nut 64 and an interior surface of the base 26 of a driven device 22. It will be recognized that when this spring 60 is in a compressed state, it will impart a force upon a driven object in resistance to the force of tension applied by the belt 38. Accordingly, as slack develops in the belt 38, the spring 60 accommodates for the slack by translating the driven device 22 along the platform 14, guided by slots 48. Fastening assembly 52, 56 operates in combination with slots 48 as previously described. In one embodiment of the present disclosure, fastening assembly 52, 56 is comprised of a nut and shoulder bushing which may be partially tightened to limit movement of the device base 26 in a direction away from the platform 14 while still allowing longitudinal movement of the base 26. Alternatively, fastening assembly 52, 56 may be tightened so that both movement in a direction away from the platform 14 and longitudinal movement of the base 26 are limited or prevented. Those working in the art will understand that fastening assembly 52, 56 may comprise bolts that are disposed within threaded holes of the platform 14 or may comprise through holes in the platform 14 and a nut 54 employed to limit movement. Additionally, it will be recognized that previously described slots 48 may be formed in either the platform 14 or the base 26 in order to accomplish objectives of the present invention.

It will be appreciated that a variety of elastic devices may be employed in place of the spring 60. For example, elastomers that bias the driven device in a direction opposite of the direction of tension of the belt may be employed to serve the purposes of applying substantially constant tension to the belt. Similarly, the spring 60, as described herein, need not necessarily take the form of a coil or helical spring. However, as metal coil springs are generally known for their elasticity and wear characteristics, they are incorporated into a preferred embodiment of the present invention.

FIG. 4 further depicts the relationship between the nut 64, indicator 34, rod 33, and indicator slot 36. As will be appreciated, external force must be applied to the nut 64 if it is to translate along the rod 33 while the rod is rotated by the handle 30. That external rotational force is applied by the resistance provided by the indicator 34. As previously discussed, the indicator 34 extends through the slot or aperture 36 formed in a side of the base 26. Accordingly, contact of the indicator 34 (which, as described below, is fixedly joined to nut 64) with a peripheral wall of the slot 36 formed in the base 26 opposes rotation, resulting in the translation of the nut 64 along the threads of the rod 33, where the direction of travel of the nut 64 is determined by the direction of rotation of the rod 33. The translation of the nut therefore allows for either the compression or extension of the spring 60.

The handle 30 allows a user to load the spring 60 to an appropriate level of tension prior to operation or place the spring 60 in a state of tension that will either translate or allow the driven device 22 to be translated to a position that will slacken the belt 38 and allow for belt repair and replacement relative to the pulley 44 of the driving device 18. It will be recognized that the spring constant needs to be correlated to the tension desired on the belt 38, as well as, the weight of the driven device 22 and other similar parameters as will be well understood by those of skill working in this art. In order to translate the driven device 22, it will be understood by those working the field that the spring 60 will need to overcome the force of friction between the base 26 and the platform 14. The force is further known to be expressed in terms of:

F_{f}=μF_{N}

where μ is the friction coefficient between the platform 14 and the driven device base 26 and F_{N} is the normal force or, in other words, the product of the mass of the driven device 22, including its base 26, and the acceleration of gravity.

Furthermore, it is desirable to employ a spring 60 of an appropriate spring constant so as to provide adequate tension on the belt 38 without over tightening the belt 38. It is known that excessive tension on the belt 38 can result in slipping and/or excessive friction upon bearings that can result in damage to the system and an inoperative state of the system. It is also known that the spring force is the product of the spring constant and the amount the spring is displaced from equilibrium. Therefore, as the spring expands from a point of initial compression, the force applied by the spring 60 on the driven device 22 will gradually decrease. Accordingly, the spring 60 must be selected with these factors in mind and for each particular application of the system.

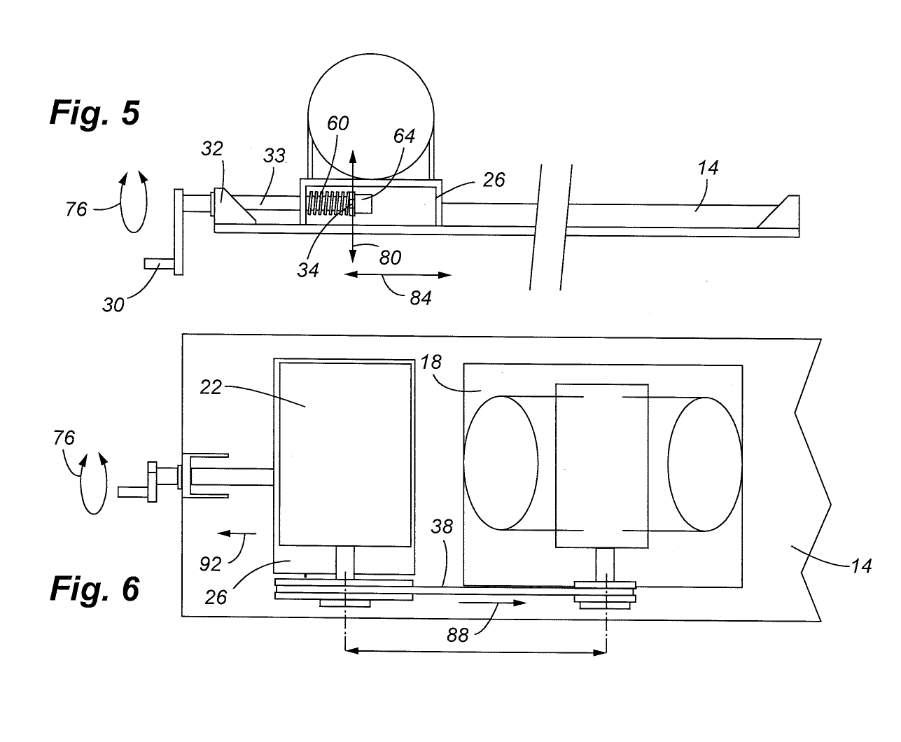

To further illustrate the operation of the present invention, FIG. 5 is a plan view of the belt tensioning system wherein forces 76, 80, and 84 are depicted. Rotation of the manually operable adjustment 30 is indicated by rotational force 76. It will be recognized that this rotation may be in either direction, thus force 76 is depicted in both clockwise and counterclockwise directions for the purposes of illustration. The direction chosen, as well as the corresponding threading chosen for the rod 33 and nut 64 will ultimately determine the direction of travel of the nut 64 along the rod 33 as previously described. The rotational force 76 applied to the handle 30 operates to rotate the rod 33. This is partially accomplished by the non-threaded through holes formed in the previously described bracket 33 and base 26. A nut 64 disposed on the rod 33 resists rotation by previously described indicator 34 which applies a force 80 in opposition to the rotational force 76. It will be recognized that the indicator 34 must be fixedly attached to the nut 64 in order to provide a resistance force 80 to the rotational force 76. It will further be recognized that this may be accomplished by, for example, welding the indicator 34 to the nut 64 or utilizing a nut 64 and indicator 34 comprising a unitary body. Given the moment and forces that will be applied to the indicator 34, it is contemplated that the indicator 34 may be formed with stress reducing fillets near the connection point between the indicator 34 and the nut 64. It will also be recognized that this translation 84 offers the ability to compress or expand the spring 60, thereby loading or unloading the spring 60 and applying force to the base 26 and moving driven device 22 in a desired longitudinal direction.

FIG. 6 is top view further illustrating operation of one embodiment of the disclosure. FIG. 6 depicts an energy source 18 and a driven device 22 connected by a belt 38. The force of tension in the belt is depicted by directional arrow 88. During a period of time where the driven device 22 is being driven by the energy source 18, the force applied by the spring 60 and resulting translation are represented by direction arrow 92. Accordingly, if the energy source 18 is fixed, force 92 will translate the driven device 22 away from the energy source 18 in a manner that maintains sufficiently constant tension 88 on the belt 38.

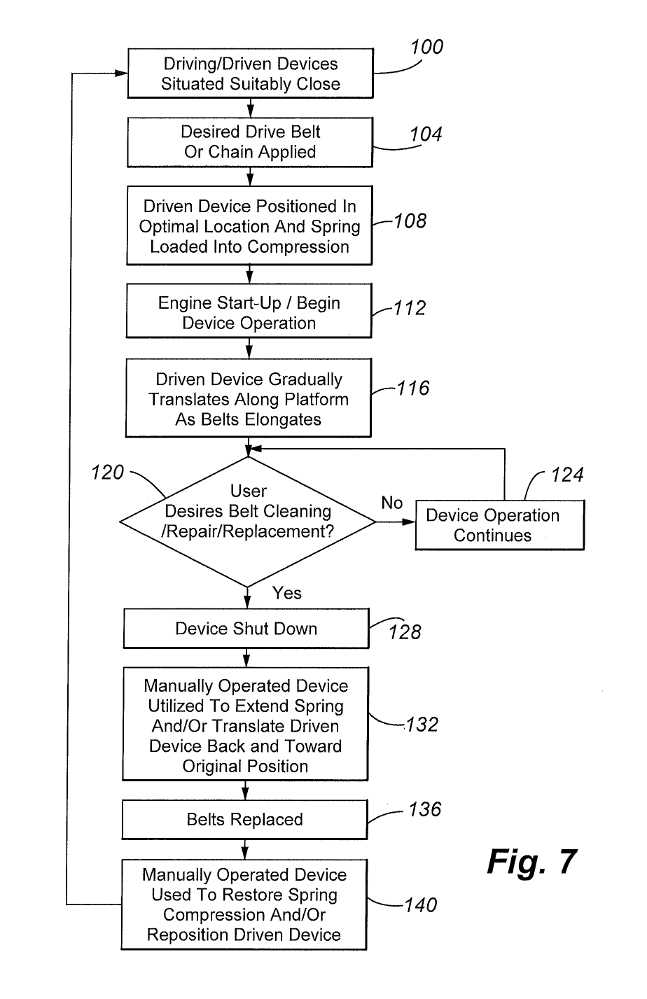

FIG. 7 is a flowchart describing the process in which one embodiment of the present invention may be utilized. Process step 100 depicts an initial step wherein a user or users selectively position the driven 22 and driving 18 devices with respect to each other. The placement may be accomplished by following the previously described tensioning system adjustment proceeding and manual adjustment method, manual positioning of the devices, or any other equivalent function. The purpose of this discussion is to now facilitate the application of one or more belts, chains, etc. as illustrated in step 104.

Step 104 refers to the application of a desired belt with consideration given to the power and torque required to drive the driven device 22, the spring force, and other relevant factors. Once drive belts or chains 38 have been properly applied to the device, the driven device 22 is then positioned with respect to the engine or driving device 18 as shown in process step 108. Step 108 may also be accomplished through the use of a manually operable device driving the nut 64, by more direct methods, such as by applying manual force to the base 26 to slide the device 22, or similar methods. In a preferred embodiment, an indicator 34 is provided on the base of the driving device 22 or on the platform to visually instruct the user as to the appropriate positioning of the devices and corresponding spring compression. Once the desired position has been obtained, engine start up and device operation may begin as shown in step 112. As previously discussed, the present invention may be employed with a variety of different driven devices 22. Accordingly, the operation described herein is not limited to any specific device. However, in a preferred embodiment, the engine drives at least one of a group of devices consisting of a pump, a compressor, an electrical generator, or a rotary shaft capable of accommodating any number of additional devices.

Process step 116 depicts another aspect of the operation of the process described herein. As it is often desirable to allow devices to operate continuously for extended periods of time, the present invention provides a device that compensates for elongation of a belt 38 or driven device 22 without user input or the need to power down the operation. It is therefore a feature of the present invention to allow for longer uninterrupted run time of driven devices without the complications associated with excessive or inadequate tension on the drive belt or chain. These advances are achieved, as will be understood by those skilled and working in this art, by the devices disclosed herein.

Step 120 is a decision step wherein the user or users of the disclosed devices determine whether or not belt removal for the purposes of repair or replacement is required. It will be recognized that in various circumstances, belt replacement will be required. For example, where a driven device 22 has been translated to its furthest possible location relative to the engine and slack is still present in the belt, a user may be compelled to remove and replace the belt. However, the present invention also contemplates providing a user with the ability to stop operation and employ the previously described methods to remove a belt before a driven device has exhausted the entirety of its potential movement. By way of example only, if it becomes apparent that cracking or other damage has developed in the belt, it is possible for a user to cease engine operation, slacken the belt by activating the manually operable handle and longitudinally moving the driven device toward the driving device, and safely replace the damaged belt. Step 124 depicts the process step wherein no change or replacement of the belt or belts is required, thus returning the user to the decision loop of step 120.

Step 128 depicts the beginning of the process required to change out belts. Step 128 involves the shut down of the engine. It will be recognized, however, that the purpose of shutting down the engine or driving device is to terminate the movement of the belt and generally allow for a safe transition of parts. Accordingly, it will further be recognized that this step may be accomplished through a variety of other means. For example, a friction disc clutch or similar disengaging mechanism may be employed to isolate the pulley and belt from the driving device, allowing belts, etc. to be changed without necessarily powering down the engine or motor.

Step 132 describes the process by which belts or chains are quickly, safely and easily removed by a user. As previously described, a nut 64 is disposed on a threaded rod 33 which extends to the interior of a driven device base 26 and may be employed to provide resistance for a spring 60. The nut 64 may be translated along a length of the rod 33 when the rod 33 is rotated and the nut indicator 34 is allowed to resist rotation and thus convert rotational energy to linear motion. By manually operating the handle 30 or similar device as previously disclosed, the nut 64 may be slid or translated along the rod 33 in a manner that allows for expansion of the spring 60. In one embodiment, where the spring is fixedly attached to the nut, the spring may be expanded beyond its equilibrium point and placed in a state of tension. By doing so, the user may position the nut 64 and spring 60 so that spring tension retracts the driven device 22 toward an original position and thereby placing the belt 38 in a slackened state. Similarly, a user may expand the spring 60 as previously described and slide or reposition the driven device 22 by manual force. By reducing the distance between the driven 22 and driving 18 devices, the belt(s) or chain(s) 38 will acquire sufficient slack for a user to safely and easily replace them. The replacement process is depicted in process step 136 of FIG. 7.

Step 140 represents the process step in which the driven device 22 is relocated to a preferred position before re-starting operation of the system, utilizing the features previously described in step 132. It will be recognized that once belt 38 is removed and replaced, it will often be necessary to reposition the driven device 22 to an appropriate position on the platform 14 and apply an appropriate amount of compression upon the spring 60. This may be accomplished by rotating the manually operable handle 30 or similar device in order to translate the nut 64 to compress the spring 60 and position the driven device 22. It will be appreciated that when the spring and belt are not in equilibrium, the driven device 22 will be translated linearly. In one embodiment, the driven device 22 may be temporarily fixed in a given position by adjusting the bolts and shoulder bushings 52, 56 previously described. In a preferred embodiment, an indicator is provided on the driven device base which corresponds to the optimum amount of spring tension when aligned with the previously described nut indicator. Once belts have been replaced, operations may be restarted according to previously described steps 100 et. seq.

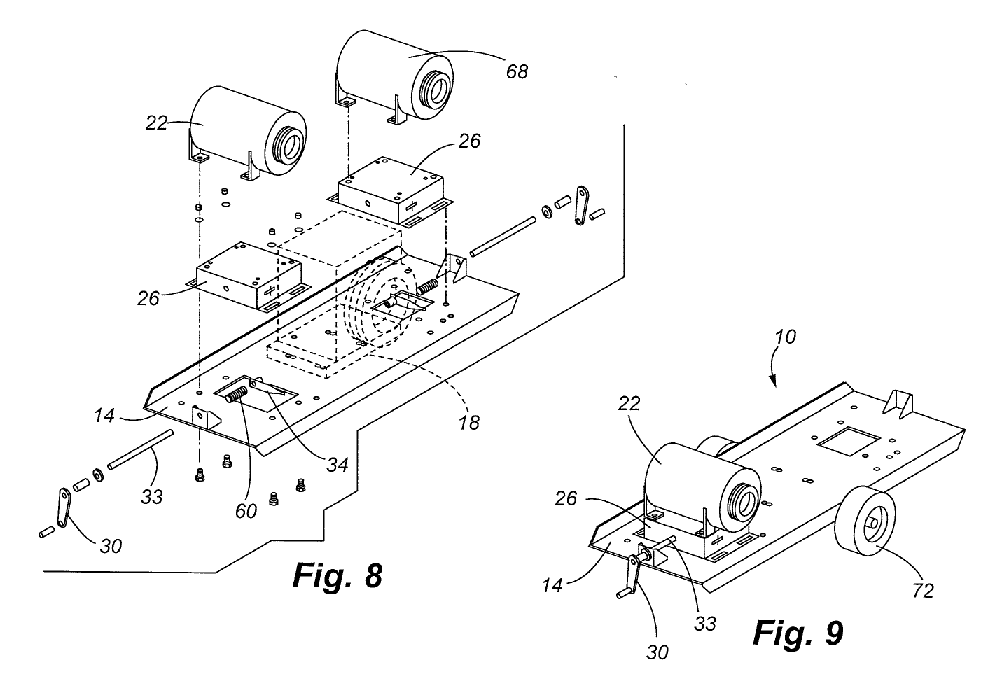

FIG. 8 is an exploded perspective view of another embodiment of the described device where a driving device 18 is situated upon a platform 14 and drives multiple belt driven devices 22, 68. As previously described, these driven devices 22, 68 may take the form of any number of devices, including but not limited to any one of the group consisting of a pump, a compressor, an electrical generator, or a rotary shaft capable of accommodating any number of additional devices. It will be appreciated that the multiple driven devices 22, 68 need not be of the same type and it may be preferable to simultaneously drive devices of different functions. The tension system for the double driven device system is basically a duplication of the single driven device tensioning system described above.

FIG. 9 is a perspective view of yet another embodiment of a device disclosed wherein the previously described devices, as well as the platform 14 are incorporated into or situated upon a movable device. It will be appreciated that the various embodiments of the present invention may be disposed upon any number of devices, such as rigid frames, floors, truck beds, trailers, and work benches, or incorporated into larger components and devices. Accordingly, the embodiment shown in FIG. 9 relate to an easily transportable device, such as a trailer, which may be moved by a variety of means, including but not limited to, human power, towing vehicles, or other mobile equipment. The self-contained automatically tension adjustable system may further include its own propulsion system. For example, the present invention may derive power from the engine or motor to propel the entire unit or may further include means, such as an engine or motor, apart from the previously disclosed engine to power wheels 72 of the device 10.

While various embodiments the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A device for use in a tensioning system comprising:
an adjustment mechanism comprising a rod, a restraining member and a biasing member wherein the restraining member is threaded upon a portion of the rod, is positioned below a moving member having at least a wall and opposes rotational movement of the rod; and
wherein the biasing member is positioned between the restraining member and the wall of the moving member such that a force is applied to the moving member to apply substantially constant desired tension in a driving member.

2. The mechanism of claim 1, wherein the restraining member is a nut with an extension that is in force transmitting contact with the moving member and opposes rotational movement.

3. The mechanism of claim 1, wherein the biasing member is a coil spring.

4. The mechanism of claim 1, wherein the moving member is a pressure washer.

5. The mechanism of claim 1, wherein the moving member is a pump.

6. The mechanism of claim 1, wherein the moving member is a rotor.

7. The mechanism of claim 1, wherein an engine transmits energy to the moving member through the driving member.

8. The mechanism of claim 1, wherein the mechanism is positioned upon a wheeled device.

9. A belt tensioning system, comprising:
a driven member, a driving member and a force transmitting device in force transmitting communication with both the driving member and the driven member;
a moving member having at least a wall in fixed communication with the driven member and movable relative to the driving member;
an adjustment mechanism comprising a rod, a restraining member and a biasing member;
wherein the restraining member is threaded upon a portion of the rod, is positioned below the moving member and substantially opposes rotational movement of the rod;
wherein the biasing member is positioned between the restraining member and the wall of the moving member such that a force is applied to the moving member; and
wherein a substantially constant tension is applied to the force transmitting device.

10. The belt tensioning system of claim 9, wherein the driven member is a pressure washer.

11. The belt tensioning system of claim 9, wherein the driven member is a vacuum pump.

12. The belt tensioning system of claim 9, wherein the driven member is a rotor.

13. The belt tensioning system of claim 9, wherein the driving member is an engine.

14. The belt tensioning system of claim 9, wherein the driving member is an electric motor.

15. The belt tensioning system of claim 9, wherein the force transmitting device is one of a belt, a cable and a chain.

16. The belt tensioning system of claim 9, wherein the moving member is a portion of the driven member.

17. The belt tensioning system of claim 9, wherein the moving member is a base portion of the driven member.

18. The belt tensioning system of claim 9, wherein the biasing member is a coil spring.

19. A belt tensioning system, comprising:
a plurality of driven members, a driving member and at least one force transmitting device in force transmitting communication with both the driving member and the plurality of driven members;
a plurality of moving members, each having at least a wall, in fixed communication with the plurality of driven members and movable relative to respective driving members;
an adjustment mechanism for each of the plurality of driven members each comprising a rod, a restraining member and a biasing member;
wherein each restraining member is threaded upon a portion of its respective rod, each positioned below their respective moving member and each substantially opposes rotational movement of their respective rods;
wherein the biasing members are positioned between each of the restraining members and the wall of each of their respective moving members such that a force is applied to each of the plurality of moving members; and
wherein a substantially constant tension is applied to the at least one force transmitting device.

20. The belt tensioning system of claim 19, wherein the driving device is an engine in force transmitting communication with two driven members; and
wherein the two driven members are selected from a group consisting of a pump, a vacuum pump, a compressor, a pressure washer and a rotary shaft.

21. The belt tensioning system of claim 19, wherein the plurality of moving members are portions of the driven members.

22. The belt tensioning system of claim 19, wherein the plurality of moving members are base portions of the driven members.

23. The belt tensioning system of claim 19, wherein the restraining member is a nut.

24. The belt tensioning system of claim 19, wherein the restraining member is a nut with an extension.

25. The belt tensioning system of claim 19, wherein the biasing member is a coil spring.

26. The belt tensioning system of claim 19, wherein the force transmitting device is one of a belt, a chain, a cable and a rope.

27. A belt tensioning system for use with a pressure washer assembly, comprising:
a pressure washer, an engine, and a belt in force transmitting communication with both the pressure washer and the engine;
a base portion in fixed communication with the pressure washer and longitudinally movable relative to the engine;
an adjustment mechanism comprising a rod, a nut, an extension and a spring;
wherein the nut is threaded upon a portion of the rod, is positioned below the pressure washer which has at least a wall and the extension opposes rotational movement of the nut;
wherein the spring is positioned between the nut and the wall of the pressure washer such that a force is applied to the pressure washer; and
wherein a substantially constant tension is applied to the belt.

28. The belt tensioning system of claim 27, wherein the belt tensioning system is mounted upon a movable device.

29. The belt tensioning system of claim 27, wherein the belt is a rubber drive belt.
